(19) United States
(12) Patent Application Publication
(10) Pub. No.: US 2003/0181558 A1
(43) Pub. Date: Sep. 25, 2003

(54) Rubber composition

(76) Inventor: Carl Walter von Hellens, Bright's Grove (CA)

Correspondence Address: BAYER POLYMERS LLC, 100 BAYER ROAD, PITTSBURGH, PA, 15205, US

(21) Appl. No.: 10/275,676

(22) PCT Filed: May 10, 2001
(86) PCT No.: PCT/CA01/00657

(30) Foreign Application Priority Data
May 12, 2000 (CA) 2,308,876

(51) Int. Cl. C08K 5/04

(52) U.S. Cl. 524/394

(57) ABSTRACT

The invention relates to novel crosslinkable carboxylated nitrile rubber compositions that also comprise a multivalent salt of an organic acid and a peroxide crosslinking agent. The compositions may also contain nitrile rubber in admixture with the carboxylated nitrile rubber. The rubber may be hydrogenated. Cured compositions made from the crosslinkable compositions display improved properties, particularly an unexpectedly high modulus.

The present invention relates to novel crosslinkable carboxylated nitrile rubber compositions having improved properties.

### BACKGROUND OF THE INVENTION

An important characteristic of a rubber composition is its elastic modulus, or stiffness. To determine this characteristic of a rubber composition, a sample of the composition is subjected to testing and there is obtained a graph of the stress applied to the sample versus the strain observed. A commonly quoted parameter for a rubber composition is the stress at 100% elongation, i.e., the stress needed to double the length of the sample. For some purposes it is desired that this stress should be as high as possible. Other characteristics of importance are the elongation at break, and the stress required to cause the break. Again, for some purposes, especially dynamic purposes it is desired that these shall be as high as possible.

### SUMMARY OF THE INVENTION

One aspect of the present invention is a process for improving the properties, especially the properties of importance for dynamic applications, of a carboxylated nitrile rubber, especially hydrogenated carboxylated nitrile rubber. Another aspect is a carboxylated nitrile rubber, especially a hydrogenated carboxylated nitrile rubber, having improved properties.

Accordingly, the present invention provides a crosslinkable rubber composition that comprises a carboxylated nitrile rubber (XNBR) or a hydrogenated carboxylated nitrile rubber (HXNBR), a peroxide curing agent and a multivalent salt of an organic acid.

The invention also provides a process for preparing a crosslinkable rubber composition, which comprises blending a carboxylated nitrile rubber or a hydrogenated carboxylated nitrile rubber, a peroxide curing agent and a multivalent salt of an organic acid.

### DESCRIPTION OF THE PREFERRED EMBODIMENTS

Many conjugated dienes are used in nitrile rubbers and these may all be used in the present invention. Mention is made of 1,3-butadiene, isoprene, 2,3-dimethyl-1,3-butadiene, 1,3-pentadiene and piperylene of which 1,3-butadiene is preferred.

The nitrile is normally acrylonitrile or methacrylonitrile or α-chloroacrylonitrile, of which acrylonitrile is preferred.

The α,β-unsaturated acid can be, for example, acrylic, methacrylic, ethacrylic, crotonic, maleic (possibly in the form of its anhydride), fumaric or itaconic acid, of which acrylic and methacrylic are preferred.

The conjugated diene usually constitutes about 50 to about 85% of the copolymer, the nitrile usually constitutes about 15 to 50% of the copolymer and the acid about 0.1 to about 10%, these percentages being by weight. The polymer may also contain an amount, usually not exceeding about 10%, of another copolymerisable monomer, for example, an ester of an unsaturated acid, say ethyl, propyl or butyl acrylate or methacrylate, or a vinyl compound, for example, styrene, α-methylstyrene or a corresponding compound bearing an alkyl substituent on the phenyl ring, for instance, a p-alkylstyrene such as p-methylstyrene.

The composition of the invention can contain other polymers in addition to the XNBR or HXNBR and mention is made particularly of nitrile rubber (NBR) and hydrogenated nitrile rubber (HNBR). Hydrogenation of nitrile rubber is well known, and both nitrile rubber and hydrogenated nitrile rubber are available commercially. As examples of hydrogenated nitrile rubber there are mentioned the products available from Bayer under the trademark Therban. Another polymer that can be present is EPDM, a terpolymer of ethylene, propylene and a non-conjugated diene, for example a cyclic or aliphatic diene such as hexadiene, dicyclopentadiene or, preferably, ethylidene-norbornene.

Carboxylated nitrile rubbers are also available commercially, and there are mentioned rubbers available from Bayer under the trade mark Krynax.

Nitrile rubbers and carboxylated nitrile rubbers that are not hydrogenated contain carbon-carbon unsaturated. Hydrogenation of these polymers enhances certain properties of these polymers but, of course, the hydrogenation process adds cost. It is found that if hydrogenated polymer is blended with unhydrogenated polymer the properties of the blend approximate much more closely to the properties of the unhydrogenated polymer than the hydrogenated polymer. No advantage is seen in blending hydrogenated and non-hydrogenated polymers. Hence, preferred embodiments of the invention include compositions containing blends of XNBR and NBR and blends of HXNBR and HNBR, but blends of XNBR and HNBR, or blends of NBR and HXNBR are not preferred.

Hydrogenated carboxylated nitrile rubbers (HXNBR) have been proposed, as have proposals for making these compounds by catalytic hydrogenation of carboxylated nitrile rubbers. No commercial HXNBR product is available. It is believed that difficulty has been encountered in achieving selective hydrogenation whereby carbon-carbon double bonds are hydrogenated but carboxyl groups are not. An attempt to get around this problem was made by hydrogenating a nitrile rubber and subsequently carboxylating by adding an unsaturated acid to the hydrogenated nitrile rubber. This process is expensive and difficult to control. A product made in this manner was commercially available but was then withdrawn, possibly because production problems prevented the obtaining of a product with consistent properties.

The present applicant has now found a process for selectively hydrogenating carbon-carbon double bonds of a carboxylated nitrile rubber without concomitant hydrogenation of carboxyl and nitrile groups. This process, and the product that is a hydrogenated carboxylated nitrile rubber free of hydrogenated carboxyl and nitrile groups, are the subject of our co-pending Canadian Patent Application Serial No 2,304,501. Preferred hydrogenated carboxylated nitrile rubbers for use in this invention are the products of this selective hydrogenation process.

This selective hydrogenation can be achieved by means of a rhodium-containing catalyst. The preferred catalyst is of the formula:

(RₘB)₁RhXₙ

in which each R is a C₁-C₈-alkyl group, a C₄-C₈-cycloalkyl group a C₆-C₁₅-aryl group or a C₇-C₁₅-aralkyl group, B is phosphorus, arsenic, sulfur, or a sulphoxide group S=0, X is hydrogen or an anion, preferably a halide and more preferably a chloride or bromide ion, 1 is 2, 3 or 4, m is 2 or 3 and n is 1, 2 or 3, preferably 1 or 3. Preferred catalysts are tris-(triphenylphosphine)-rhodium(I)-chloride, tris(triphenylphosphine)-rhodium(III)-chloride and tris-(dimethylsulphoxide)-rhodium(III)-chloride, and tetrakis-(triphenylphosphine)-rhodium hydride of formula ((C₆H₅)₃P)₄RhH, and the corresponding compounds in which triphenylphosphine moieties are replaced by tricyclohexylphosphine moieties. The catalyst can be used in small quantities. An amount in the range of 0.01 to 1.0% preferably 0.03% to 0.5%, most preferably 0.06% to 0.12% especially about 0.08%, by weight based on the weight of polymer is suitable.

The catalyst is used with a co-catalyst that is a ligand of formula RₘB, where R, m and B are as defined above, and m is preferably 3. Preferably B is phosphorus, and the R groups can be the same or different. Thus there can be used a triaryl, trialkyl, tricycloalkyl, diaryl monoalkyl, dialkyl monoaryl diaryl monocycloalkyl, dialkyl monocycloalkyl, dicycloalkyl monoaryl or dicycloalkyl monoaryl co-catalysts. Examples of co-catalyst ligands are given in U.S. Pat. No. 4,631,315, the disclosure of which is incorporated by reference. The preferred co-catalyst ligand is triphenylphosphine. The co-catalyst ligand is preferably used in an amount in the range 0.3 to 5%, more preferably 0.5 to 4% by weight, based on the weight of the terpolymer. Preferably also the weight ratio of the rhodium-containing catalyst compound to co-catalyst is in the range 1:3 to 1:55, more preferably in the range 1:5 to 1:45. The weight of the co-catalyst, based on the weight of one hundred parts of rubber, is suitably in the range 0.1 to 33, more suitably 0.5 to 20 and preferably 1 to 5, most preferably greater than 2 to less than 5.

A co-catalyst ligand is beneficial for the selective hydrogenation reaction. There should be used no more than is necessary to obtain this benefit, however, as the ligand will be present in the hydrogenated product. For instance triphenylphosphine is difficult to separate from the hydrogenated product, and if it is present in any significant quantity may create some difficulties in processing of the product.

The hydrogenation reaction can be carried out in solution. The solvent must be one that will dissolve carboxylated nitrile rubber. This limitation excludes use of unsubstituted aliphatic hydrocarbons. Suitable organic solvents are aromatic compounds including halogenated aryl compounds of 6 to 12 carbon atoms. The preferred halogen is chlorine and the preferred solvent is a chlorobenzene, especially monochlorobenzene. Other solvents that can be used include toluene, halogenated aliphatic compounds, especially chlorinated aliphatic compounds, ketones such as methyl ethyl ketone and methyl isobutyl ketone, tetrahydrofuran and dimethylformamide. The concentration of polymer in the solvent is not particularly critical but is suitably in the range from 1 to 30% by weight, preferably from 2.5 to 20% by weight, more preferably 10 to 15% by weight. The concentration of the solution may depend upon the molecular weight of the carboxylated nitrile rubber that is to be hydrogenated. Rubbers of higher molecular weight are more difficult to dissolve, and so are used at lower concentration.

The reaction can be carried out in a wide range of pressures, from 10 to 250 atm and preferably from 50 to 100 atm. The temperature range can also be wide. Temperatures from 60 to 160°, preferably 100 to 160° C., are suitable and from 110 to 140° C. are preferred. Under these conditions, the hydrogenation is usually completed in about 3 to 7 hours. Preferably the reaction is carried out, with agitation, in an autoclave.

Hydrogenation of carbon-carbon double bonds improves various properties of the polymer, particularly resistance to oxidation. It is preferred to hydrogenate at least 80% of the carbon-carbon double bonds present. For some purposes it is desired to eliminate all carbon-carbon double bonds, and hydrogenation is carried out until all, or at least 99%, of the double bonds are eliminated. For some other purposes, however, some residual carbon-carbon double bonds may be required and reaction may be carried out only until, say, 90% or 95% of the bonds are hydrogenated. The degree of hydrogenation can be determined by infrared spectroscopy or ¹H-NMR analysis of the polymer.

In some circumstances the degree of hydrogenation can be determined by measuring iodine value. This is not a particularly accurate method, and it cannot be used in the presence of triphenyl phosphine, so use of iodine value is not preferred.

It can be determined by routine experiment what conditions and what duration of reaction time result in a particular degree of hydrogenation. It is possible to stop the hydrogenation reaction at any preselected degree of hydrogenation. The degree of hydrogenation can be determined by ASTM D5670-95. See also Dieter Brueck, Kautschuk+Gummi Kunststoffe, Vol 42, No 2/3 (1989), the disclosure of which is incorporated herein by reference. The process of the invention permits a degree of control that is of great advantage as it permits the optimisation of the properties of the hydrogenated polymer for a particular utility.

As stated, the hydrogenation of carbon-carbon double bonds is not accompanied by reduction of carboxyl groups. As demonstrated in the examples below, 95% of the carbon-carbon double bonds of a carboxylated nitrile rubber were reduced with no reduction of carboxyl and nitrile groups detectable by infrared analysis. The possibility exists, however, that reduction of carboxyl and nitrile groups may occur to an insignificant extent, and the invention is considered to extend to encompass any process or production in which insignificant reduction of carboxyl groups has occurred. By insignificant is meant that less than 0.5%, preferably less than 0.1%, of the carboxyl or nitrile groups originally present have undergone reduction.

To extract the polymer from the hydrogenation mixture, the mixture can be worked up by any suitable method. One method is to distil off the solvent. Another method is to inject steam, followed by drying the polymer. Another method is to add alcohol, which causes the polymer to coagulate.

The catalyst can be recovered by means of a resin column that absorbs rhodium, as described in U.S. Pat. No. 4,985,540, the disclosure of which is incorporated herein by reference.

The hydrogenated carboxylated nitrile rubber (HXNBR) of the invention can be crosslinked. Thus, it can be vulcanized using sulphur or sulphur-containing vulcanizing agents, in known manner. Sulphur vulcanization requires that there be some unsaturated carbon-carbon double bonds in the polymer, to serve as reactions sites for addition of sulphur atoms to serve as crosslinks. If the polymer is to be sulphur-vulcanized, therefore, the degree of hydrogenation is controlled to obtain a product having a desired number of residual double bonds. For many purposes a degree of hydrogenation that results in about 3 or 4% residual double bonds (RDB), based on the number of double bonds initially present, is suitable. As stated above, the process of the invention permits close control of the degree of hydrogenation.

The HXNBR can be crosslinked with peroxide crosslinking agents, again in known manner. Peroxide crosslinking does not require the presence of double bonds in the polymer, and results in carbon-containing crosslinks rather than sulphur-containing crosslinks. As peroxide crosslinking agents there are mentioned dicumyl peroxide, di-t-butyl peroxide, benzoyl peroxide, 2,5-dimethyl-2,5-di(t-butylperoxy)-hexyne-3 and 2,5-dimethyl-2,5-di(benzoylperoxy)hexane and the like. They are suitably used in amounts of about 0.2 to 20 parts by weight, preferably 1 to 10 parts by weight, per 100 parts of rubber.

The HXNBR can also be crosslinked via the carboxyl groups, by means of a multivalent ion, especially a metal ion, that is ionically bound to carboxyl groups on two different polymer chains. This may be done, for example, with zinc, magnesium, calcium or aluminum salts. The carboxyl groups can also be crosslinked by means of amines, especially diamines, that react with the carboxyl group. Mention is made of α,ω-alkylenediamines, such as 1,2-ethylene diamine, 1,3-propylene diamine, and 1,4-butylene diamine, and also 1,2-propylene diamine.

The carboxylated nitrile rubber or hydrogenated carboxylated nitrile rubber, is admixed with a salt of a multivalent cation and an organic acid. Suitable multivalent cations are derived from metals, of which zinc, magnesium, calcium and aluminum are mentioned. As organic acids, there are mentioned aliphatic saturated and unsaturated acids having up to 8 carbon atoms, preferably up to 6 carbon atoms. The preferred organic acids are acrylic and methacrylic acids and the preferred salts are zinc acrylate and zinc methacrylate.

The amount of the salt should be at least about 2 parts preferably at least about 5 parts by weight, per 100 parts by weight (phr) of rubber. The more of the salt that is added the greater the effect in enhancing the modulus of the cured composition, as demonstrated in the examples below. The upper limit on the amount of the salt is not particularly critical. There can be used up to about 100 parts by weight of salt, per 100 parts by weight of rubber.

The carboxylated nitrile rubber or hydrogenated carboxylated nitrile rubber is admixed with the salt and a peroxide crosslinking agent and crosslinked in known manner. Suitable organic peroxide crosslinking agents include dicumyl peroxide, di-t-butyl peroxide, benzoyl peroxide 2,5-dimethyl-2,5-di(t-butylperoxy)-hexyne 3 and 2,5-dimethyl-2,5-di(benzoylperoxy)hexane and the like. They are suitably used in amounts of about 0.2 to 20 parts by weight, preferably 1 to 10 parts by weight, per 100 parts of rubber.

The compositions of the invention may include usual ingredients such as reinforcing fillers, for example carbon black, white carbon, calcium carbonate silica, clay, talc, plasticizers, antioxidants, ultra violet absorber, and the like.

As demonstrated in the examples below, the compositions of the invention have lower maximum values of tan δ, and those maximum values occur at the same, or lower, temperatures than with compositions that do not contain a blend of polymers as called for in the invention. The compositions of the invention also display steeper gradients, i.e. higher modulus, on the usual stress/strain curve and, in many cases, increased elongation at break. This renders them particularly suitable for dynamic applications such as, for example, in hard rolls used in paper-making machinery, in automotive timing belts and in belts for use in automatic continuously variable transmissions.

The invention is further illustrated in the following examples and the accompanying drawings, of which:

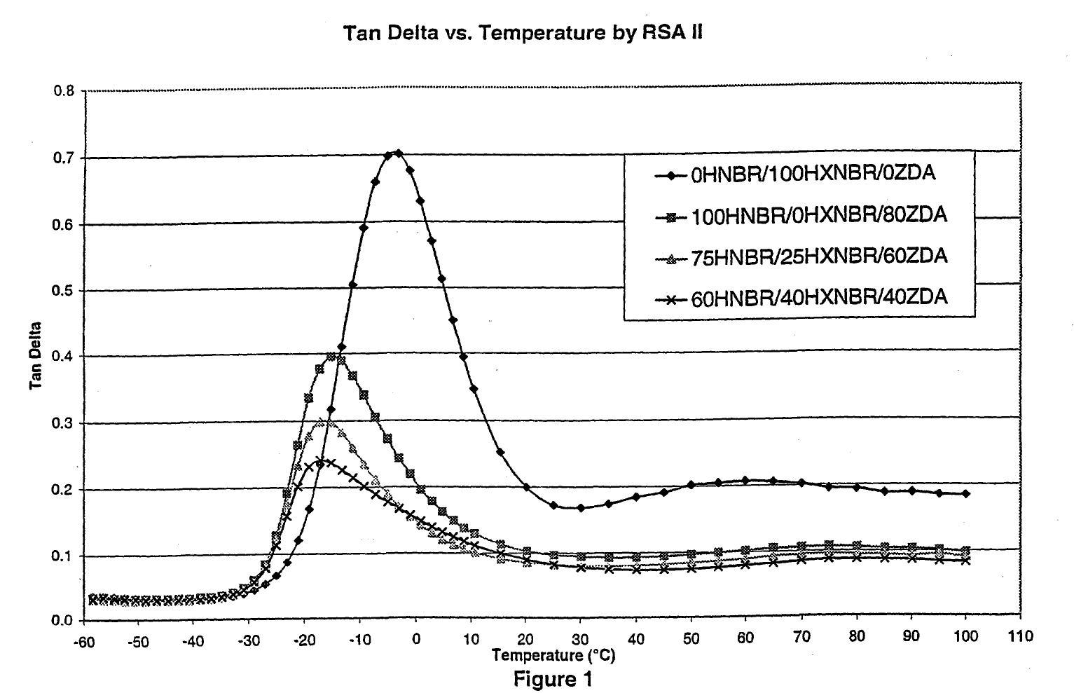

FIG. 1 is a graph of tan delta versus temperature for various compositions;

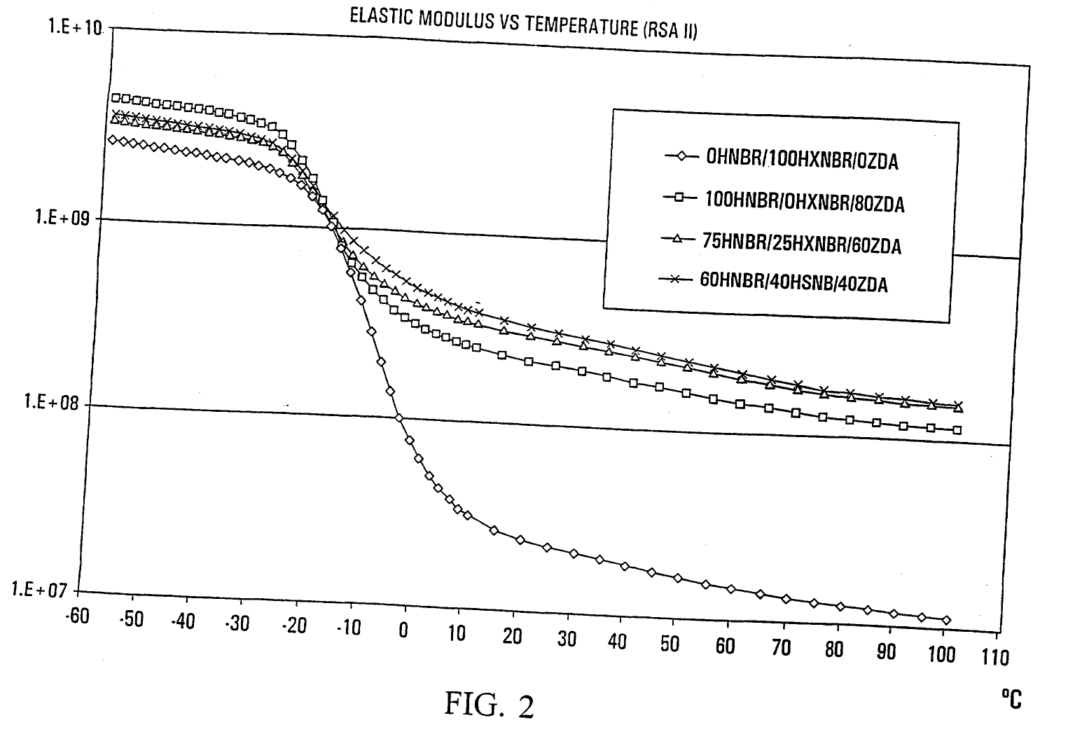

FIG. 2 is a graph of elastic modulus versus temperature for the compositions of FIG. 1;

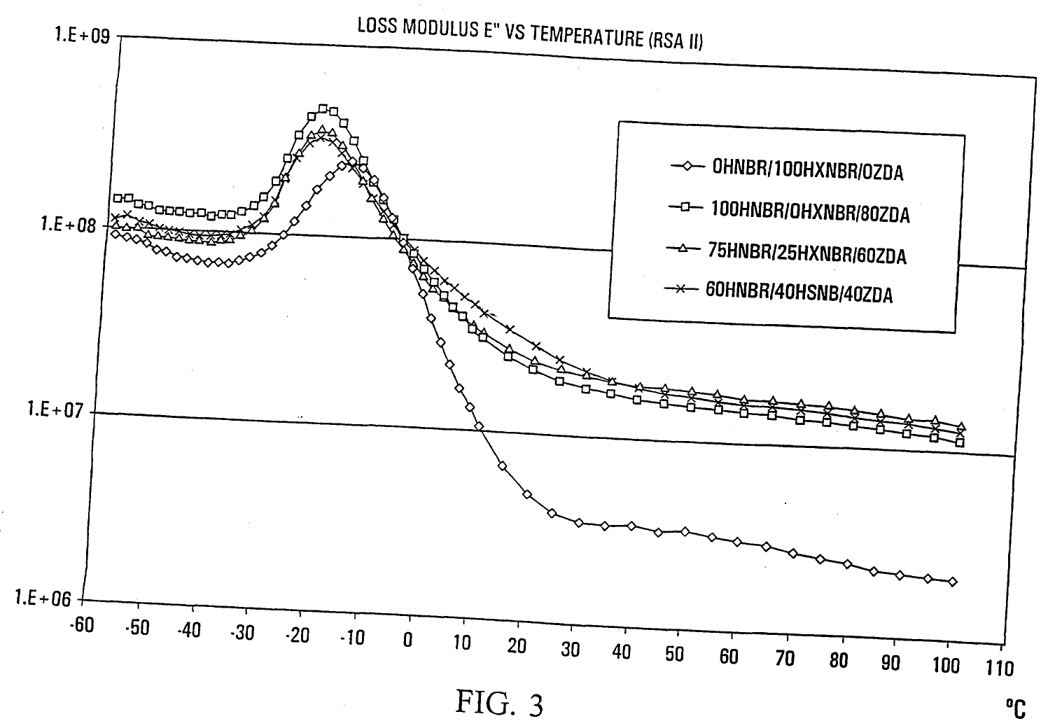

FIG. 3 is a graph of loss modulus versus temperature for the compositions of FIG. 1;

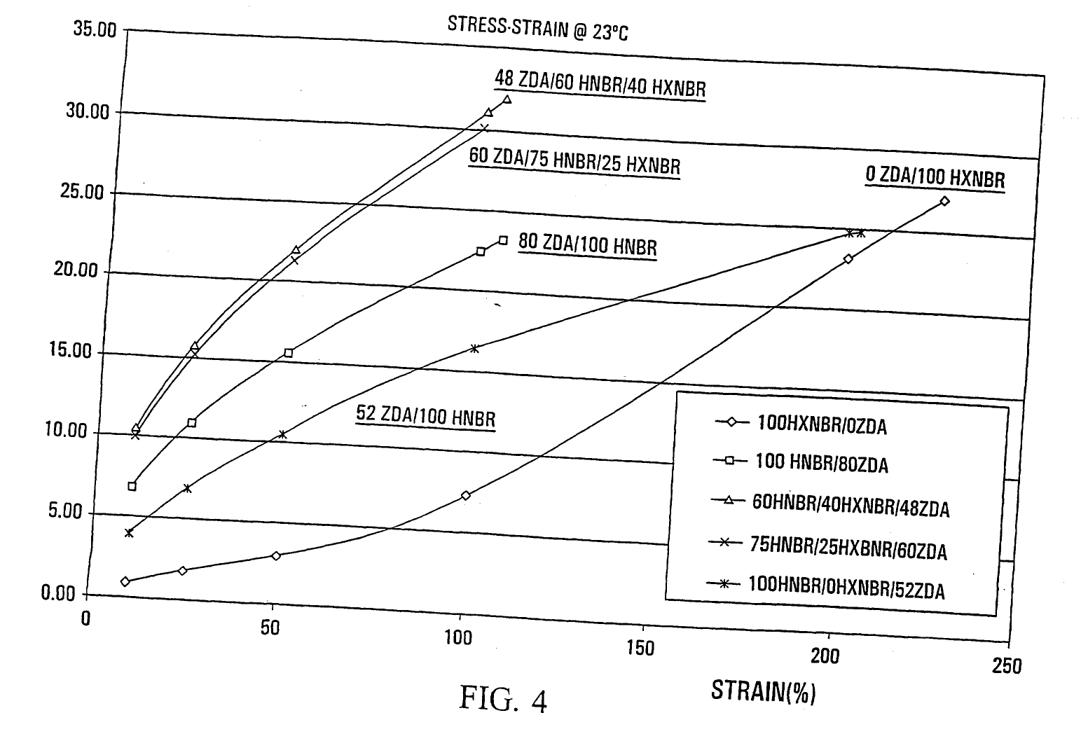

FIG. 4 is a graph of stress versus strain for various compositions;

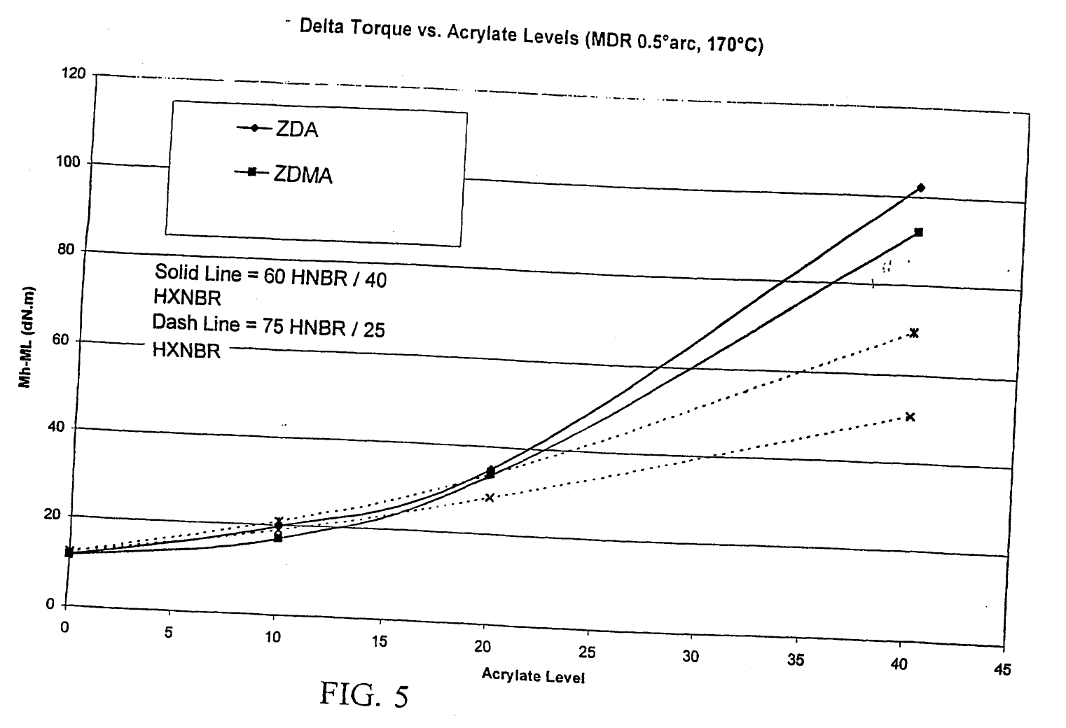

FIG. 5 is a graph of delta torque versus composition for various compositions;

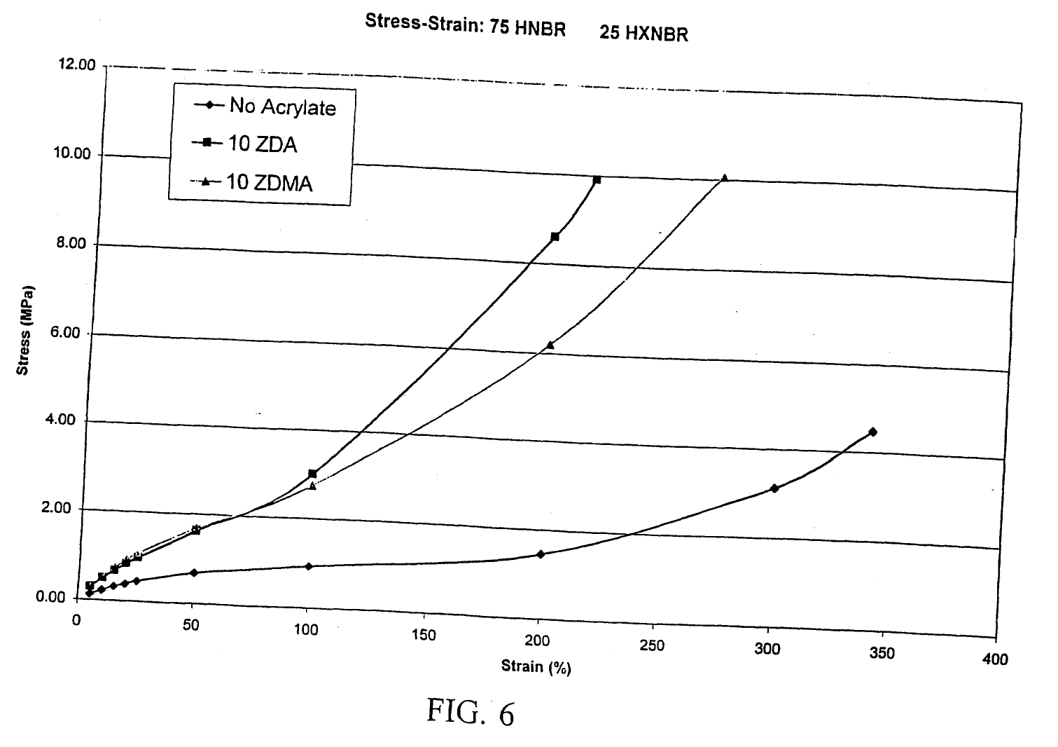

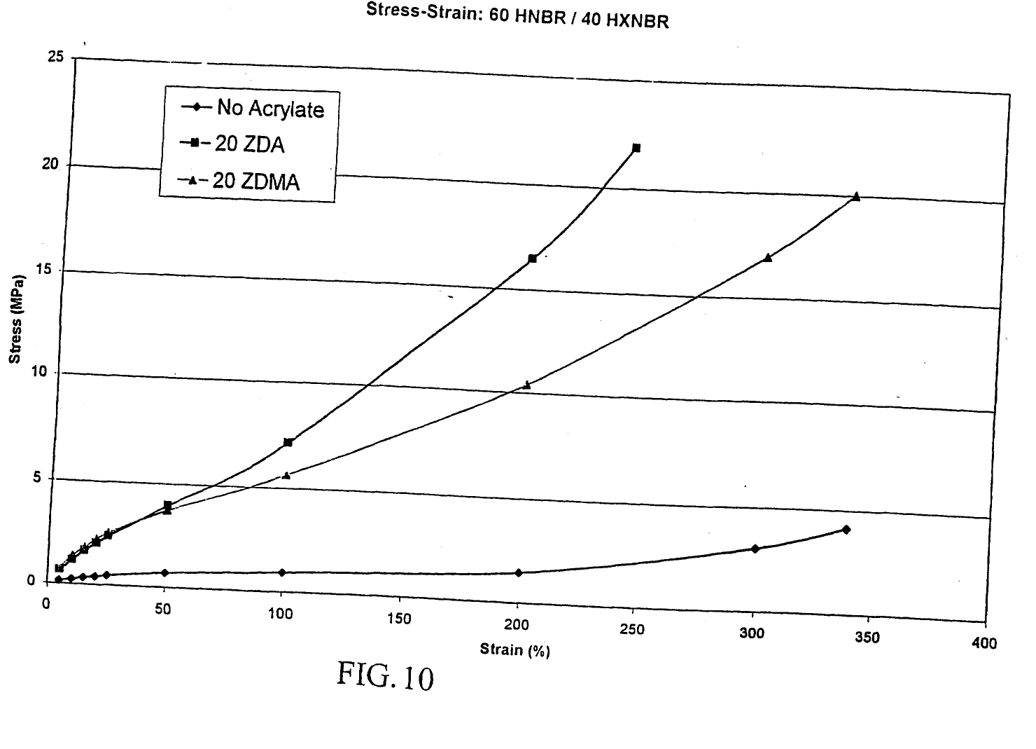

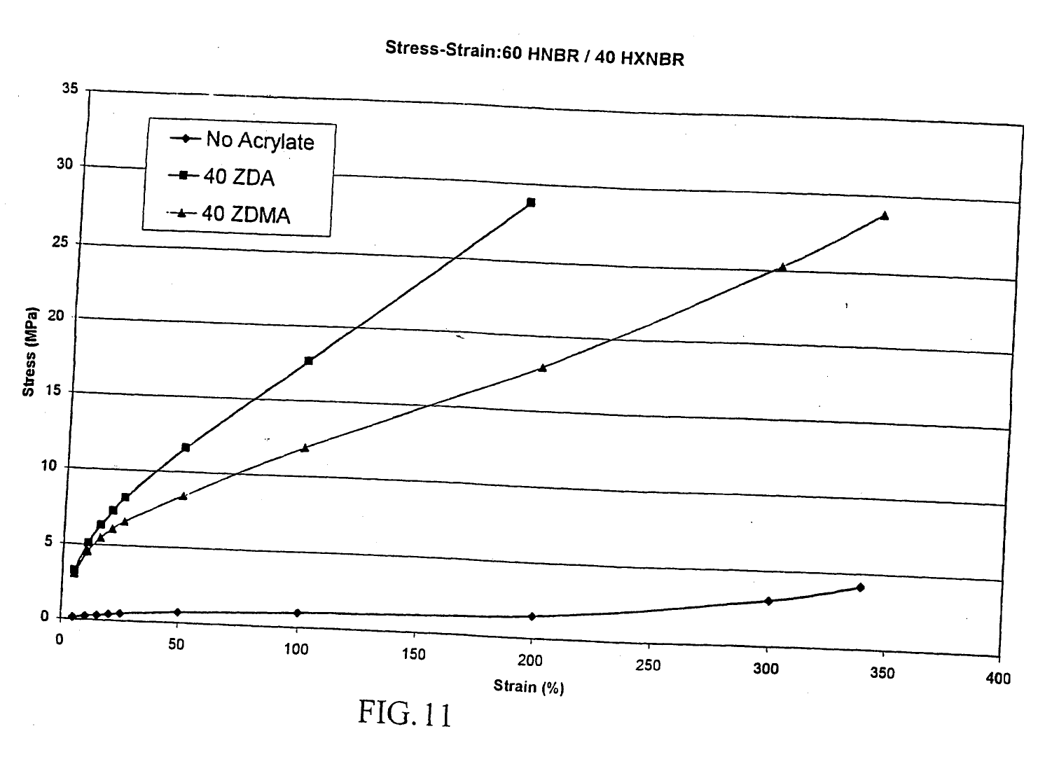

FIGS. 6 to 13 is a graph of stress versus strain for various compositions;

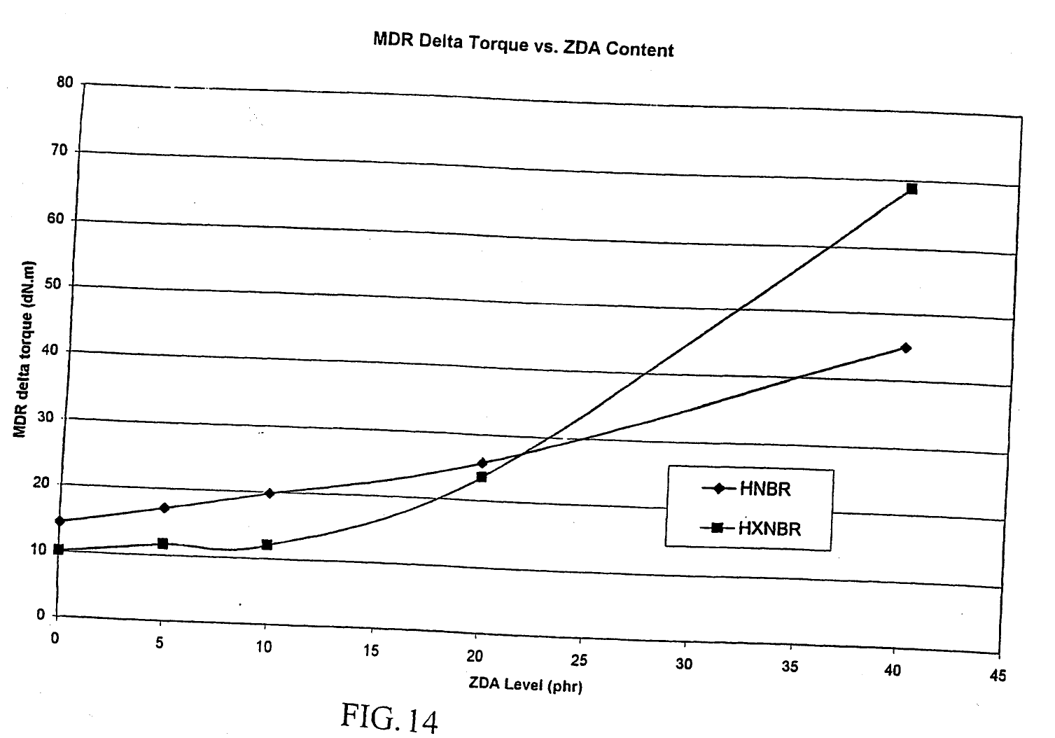

FIG. 14 is a graph of delta torque versus salt content; and

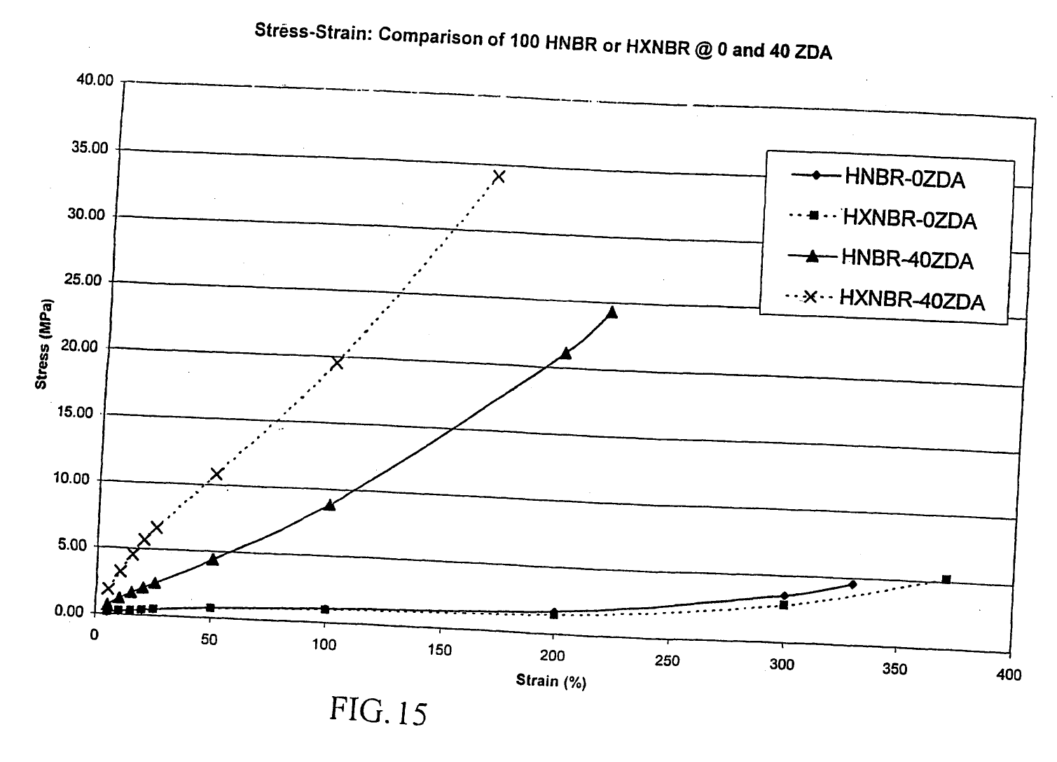

FIG. 15 is a graph of stress versus strain for various compositions.

### EXAMPLES 1

In this example there was used as HNBR a composition composed of 50% of a hydrogenated nitrile rubber having an acrylonitrile content of 34%, the balance butadiene, and a residual double bond content (RDB) of 6%, 40% of zinc diacrylate (ZDA) and 10% of epoxidised soybean oil plasticizer. As HXNBR there was used a carboxylated nitrile rubber composed of 28% acrylonitrile, 7% methacrylic acid and the balance butadiene, hydrogenated to an RDB of 5%. The HXNBR was obtained by hydrogenating a carboxylated nitrile rubber in the presence of a rhodium compound as catalyst, in accordance with Applicant's co-pending Canadian Patent Application Serial No 2,304,501. A typical hydrogenation procedure is given below, for reference. Also used were carbon black (N 330 VULCAN 3), a 50-50 mixture of zinc oxide and zinc peroxide (STRUKTOL ZP 1014), and a benzoyl peroxide crosslinking agent (VULCUP 40 KE).

Preparation of HXNBR

In a lab experiment with a 6% polymer load, 184 g of a statistical methacrylic acid-acrylonitrile-butadiene terpolymer containing 28% by weight of acrylonitrile, 7% methacrylic acid, 65% butadiene, ML 1+4/100° C.=40 (Krynac X 7.40, commercially available from Bayer), in 2.7 kg of chlorobenzene was introduced into a 2 US gallon Parr high-pressure reactor. The reactor was degassed 3 times with pure H₂ (100-200 psi) under full agitation. The temperature of the reactor was raised to 130° C. and a solution of 0.139 g (0.076 phr) of tris-(triphenylphosphine)-rhodium-(I) chloride catalyst and 2.32 g of co-catalyst triphenylphosphine (TPP) in 60 ml of monochlorobenzene having an oxygen content less than 5 ppm was then charged to the reactor under hydrogen. The temperature was raised to 138° C. and the pressure of the reactor was set at 1200 psi (83 atm). The reaction temperature and hydrogen pressures of the reactor were maintained constant throughout the whole reaction. The degree of hydrogenation was monitored by sampling after a certain reaction time followed by Fourier Transfer Infra Red Spectroscopy (FTIR) analysis of the sample. Reaction was carried out for 140 min at 138° C. under a hydrogen pressure of 83 atmospheres. Thereafter the chlorobenzene was removed by the injection of steam and the polymer was dried in an oven at 80° C. The degree of hydrogenation was 95% (as determined by infrared spectroscopy and ¹H-NMR). The FTIR result showed that the nitrile groups and the carboxylic acid groups of the polymer remained intact after the hydrogenation, indicating that the hydrogenation was selective towards the C═C bonds only. The peak for carbon-carbon double bonds almost completely disappeared after hydrogenation, consistent with there being 5% of residual double bonds. The peaks for the nitrile groups and for the carbonyl group of the carboxyl group remained, indicating that there had been no detectable reduction of nitrile and carboxyl groups.

The following compositions were blended, in accordance with the details given in Table 1

TABLE 1

| | | a | b | c | d |
|---|---|---|---|---|---|
| | | ZDA | | | |
| | | 80 | 60 | 48 | 0 |
| | | HNBR | | | |
| | | 100 | 75 | 60 | 0 |
| | | HXNBR | | | |
| | | 0 | 25 | 40 | 100 |
| HNBR | 1A | 200 | 150 | 120 | 0 |
| HXNBR | 1A | 0 | 25 | 40 | 100 |
| CARBON BLACK, | 1B | 30 | 30 | 30 | 30 |
| N 330 | | | | | |
| VULCAN 3 | | | | | |
| STRUKTOL ZP | 1C | 7 | 7 | 7 | 7 |
| 1014 | | | | | |
| VULCUP 40KE | 1C | 6 | 6 | 6 | 6 |
| | Total | 243 | 218 | 203 | 143 |
| Specific Gravity | | 1.22 | 1.2 | 1.187 | 1.109 |

The compositions were mixed in a 6×12 inch mill of 1000 g capacity that was supplied with cooling water at 30° C., in accordance with the following:

| | |
|---|---|
| 0 min | Band rubbers (1A) |
| 2 min | Slowly add “1B”; make 3/4 cuts. |
| 11 min | Slowly add “1C”; make 3/4 cuts |
| 12 min | Remove and refine (6 passes). |

Characteristics of the compositions are given in Table 2.

TABLE 2

| | 00KZ . . . | | | |
|---|---|---|---|---|
| | a | b | c | d |
| | ZDA | | | |
| | 80 | 60 | 48 | 0 |
| | HNBR | | | |
| | 100 | 75 | 60 | 0 |
| | HXNBR | | | |
| | 0 | 25 | 40 | 100 |
| COMPOUND MOONEY | 31 | 61.6 | 88.7 | 103 |
| VISCOSITY | | | | |
| ML 1 + 4′ @ 100° C. | | | | |
| COMPOUND MOONEY SCORCH | | | | |
| Large Rotor | | | | |
| t5 @ 135° C. (min) | 24.0 | 11.2 | 7.3 | 15.3 |
| Moving Die Rheometer | | | | |
| (MDR) CURE | | | | |
| CHARACTERISTICS | | | | |
| Frequency 1.7 Hz; | | | | |
| 170° C.; | | | | |
| 0.5° arc; 60′. | | | | |
| MH (max torque) (dN.m) | 81.02 | 142.32 | 139.32 | 17.22 |
| ML (min torque) (dN.m) | 0.42 | 0.82 | 1.53 | 1.58 |
| Delta MH-ML (dN.m) | 80.6 | 141.5 | 137.79 | 15.64 |

| | | 25 | 26 | 27 | 30 |
|---|---|---|---|---|---|
| | | ZDA | | | |
| | | 80 | 60 | 48 | 0 |
| | | HNBR | | | |
| | | 100 | 75 | 60 | 0 |
| | | HXNBR | | | |
| | | 0 | 25 | 40 | 100 |
| STRESS STRAIN | | | | | |
| (DUMBELLS) | | | | | |
| Cure Time at 170° C., | | 11 | 10 | 9 | 26 |
| (min) | | | | | |
| | Tested @ | | | | |
| | 23° C. | | | | |
| Stress @ 10 (MPa) | | 6.81 | 10.03 | 10.41 | 0.94 |
| Stress @ 25 (MPa) | | 10.89 | 15.24 | 15.86 | 1.73 |
| Stress @ 50 (MPa) | | 15.60 | 21.38 | 22.02 | 2.96 |
| Stress @ 100 (MPa) | | 22.40 | | 31.06 | 7.17 |
| Stress @ 200 (MPa) | | | | | 23.15 |
| Stress @ 300 (MPa) | | | | | |
| Ultimate Tensile (MPa) | | 23.25 | 30.06 | 31.96 | 27.07 |
| Ultimate Elongation (%) | | 106 | 99 | 105 | 225 |
| Hard. Shore A2 Inst. | | 90 | 91 | 93 | 76 |
| (pts.) | | | | | |

It is clearly seen that the compositions with ZDA and HXNBR, i.e., compositions b and c display higher values for Delta MH-ML and for the modulus than comparative compositions and a and d.

### EXAMPLE 2

In this example the HNBR was the same one as was used in Example 1, except that it was not in a blend with zinc diacrylate and epoxidised soybean oil. The HXNBR was the same as used in Example 1. There were also used epoxidised soybean oil (PARAPLEX G-62), zinc diacrylate (SARTOMER 633), zinc dimethacrylate (SARTOMER 634), an antioxidant (VULKANOX ZMB-2/C5 (ZMMBI)) and a benzoyl peroxide curing agent (VULCUP 40 KE)

Compositions were made up, whose details are given in Table 3.

TABLE 3

| | | a | b | c | d | e | f | g | h | I | j |
|---|---|---|---|---|---|---|---|---|---|---|---|
| | | Polymer | | | | | | | | | |
| | | HNBR | HXNBR | HNBR | HXNBR | HNBR | HXNBR | HNBR | HXNBR | HNBR | HXNBR |
| | | ZDA Level | | | | | | | | | |
| | | 0 | 0 | 5 | 5 | 10 | 10 | 20 | 20 | 40 | 40 |
| HNBR | | 100 | | 100 | | 100 | | 100 | | 100 | |
| HXNBR | | | 100 | | 100 | | 100 | | 100 | | 100 |
| 101299 (J- | 1A | | | | | | | | | | |
| 11492) | | | | | | | | | | | |
| PARAPLEX G-62 | 1B | 5 | 5 | 5 | 5 | 5 | 5 | 5 | 5 | 5 | 5 |
| SARTOMER 633 | 1B | 0 | 0 | 5 | 5 | 10 | 10 | 20 | 20 | 40 | 40 |
| (SR633) | | | | | | | | | | | |
| VULCUP 40KE | 1C | 6 | 6 | 6 | 6 | 6 | 6 | 6 | 6 | 6 | 6 |
| | Total | 111 | 111 | 116 | 116 | 121 | 121 | 131 | 131 | 151 | 151 |
| Specific | | 0.971 | 0.971 | 0.988 | 0.988 | 1.003 | 1.003 | 1.032 | 1.032 | 1.082 | 1.082 |
| Gravity | | | | | | | | | | | |

The mixing was carried out in a 6×12 inch mill of 1000 g capacity supplied with water at 30° C., in accordance with the following:

| | |
|---|---|
| 0 min | Band rubber “1A”; make 3/4 cuts |
| 1 min | Slowly add “1B”; make 3/4 cuts |
| 7 min | Slowly add “1C”; make 3/4 cuts |
| 10 min | Remove |
| Refine (6 passes) | |

Properties of the cured compositions are given in Table 4.

TABLE 4

| | a | b | c | d | e | f | g | h | i | j |
|---|---|---|---|---|---|---|---|---|---|---|
| | Polymer | | | | | | | | | |
| | HNBR | HXNBR | HNBR | HXNBR | HNBR | HXNBR | HNBR | HXNBR | HNBR | HXNBR |
| | ZDA Level | | | | | | | | | |
| | 0 | 0 | 5 | 5 | 10 | 10 | 20 | 20 | 40 | 40 |
| MDR CURE | | | | | | | | | | |
| CHARACTERISTICS | | | | | | | | | | |
| Frequency: | | | | | | | | | | |
| 1.7 Hz; 170° C.; | | | | | | | | | | |
| 1/2°; 60′ | | | | | | | | | | |
| MH | 15.00 | 10.99 | 17.87 | 13.35 | 20.59 | 14.28 | 26.44 | 25.70 | 45.74 | 71.58 |
| (dN.m) | | | | | | | | | | |
| ML | 0.65 | 0.87 | 0.76 | 1.68 | 0.75 | 2.25 | 0.68 | 2.04 | 0.61 | 2.70 |
| (dN.m) | | | | | | | | | | |
| Delta MH-ML | 14.36 | 10.12 | 17.10 | 11.67 | 19.85 | 12.03 | 25.76 | 23.66 | 45.13 | 68.88 |
| (dN.m) | | | | | | | | | | |
| STRESS STRAIN | | | | | | | | | | |
| (DUMBELLS) | | | | | | | | | | |
| Cure Time at | 15 | 31 | 16 | 12 | 16 | 10 | 16 | 8 | 14 | 9 |
| 170° C., (min) | | | | | | | | | | |
| Stress @ 5 | 0.15 | 0.15 | 0.18 | 0.20 | 0.22 | 0.28 | 0.31 | 0.55 | 0.71 | 1.87 |
| (MPa) | | | | | | | | | | |
| Stress @ 10 | 0.26 | 0.26 | 0.32 | 0.35 | 0.37 | 0.49 | 0.57 | 0.98 | 1.25 | 3.29 |
| (MPa) | | | | | | | | | | |
| Stress @ 15 | 0.35 | 0.35 | 0.43 | 0.47 | 0.51 | 0.69 | 0.77 | 1.38 | 1.71 | 4.57 |
| (MPa) | | | | | | | | | | |
| Stress @ 20 | 0.43 | 0.42 | 0.54 | 0.57 | 0.64 | 0.85 | 0.95 | 1.75 | 2.10 | 5.68 |
| (MPa) | | | | | | | | | | |
| Stress @ 25 | 0.50 | 0.49 | 0.62 | 0.67 | 0.75 | 1.00 | 1.12 | 2.16 | 2.47 | 6.60 |
| (MPa) | | | | | | | | | | |
| MDR CURE | | | | | | | | | | |
| CHARACTERISTICS | | | | | | | | | | |
| Stress @ 50 | 0.76 | 0.71 | 0.97 | 1.05 | 1.16 | 1.77 | 1.81 | 4.68 | 4.41 | 10.84 |
| (MPa) | | | | | | | | | | |
| Stress @ 100 | 1.05 | 0.95 | 1.50 | 1.93 | 1.97 | 3.91 | 3.75 | 12.03 | 8.87 | 19.58 |
| (MPa | | | | | | | | | | |
| Stress @ 200 | 1.69 | 1.40 | 3.90 | 6.74 | 5.62 | | 12.09 | | 21.11 | |
| (MPa) | | | | | | | | | | |
| Stress @ 300 | 3.53 | 2.79 | | | | | | | | |
| (MPa) | | | | | | | | | | |
| Ultimate | 4.58 | 5.20 | 5.55 | 10.36 | 7.06 | 5.40 | 13.38 | 19.95 | 24.36 | 34.20 |
| Tensile (MPa) | | | | | | | | | | |
| Ultimate | 330 | 371 | 233 | 238 | 230 | 112 | 206 | 151 | 219 | 167 |
| Elongation (%) | | | | | | | | | | |
| Hard. Shore A2 | 45 | 44 | 51 | 55 | 55 | 60 | 64 | 72 | 75 | 90 |
| Inst. (pts.) | | | | | | | | | | |

It will be seen that addition of ZDA that improves the modulus of both HNBR and HXNBR but, unexpectedly, the improvement at higher levels of ZDA is much greater in HXNBR than HNBR. This is also shown in FIG. 14.

### EXAMPLE 3

This example compares the effects of ZDA and ZDMA in blends of 75HNBR/25HXNBR. The compositions are given in Table 5.

TABLE 5

| | | a | b | c | d | e | f | g | h |
|---|---|---|---|---|---|---|---|---|---|
| | | ZDA level | | | | | | | |
| | | 0 | 10 | 20 | 40 | 0 | 0 | 0 | 20 + A/O |
| | | ZDMA level | | | | | | | |
| | | 0 | 0 | 0 | 0 | 10 | 20 | 40 | 0 |
| HNBR | 1A | 75 | 75 | 75 | 75 | 75 | 75 | 75 | 75 |
| HXNBR | 1A | 25 | 25 | 25 | 25 | 25 | 25 | 25 | 25 |
| NAUGARD 445 | 1B | | | | | | | | 1.1 |
| PARAPLEX G-62 | 1B | 5 | 5 | 5 | 5 | 5 | 5 | 5 | 5 |
| SARTOMER 633 (SR633) | 1B | 0 | 10 | 20 | 40 | 0 | 0 | 0 | 20 |
| SARTOMER 634 (SR634) | 1B | 0 | 0 | 0 | 0 | 10 | 20 | 40 | 0 |
| VULKANOX ZMB-2/C5 | 1B | | | | | | | | 0.4 |
| (ZMMBI) | | | | | | | | | |
| VULCUP 40KE | 1C | 6 | 6 | 6 | 6 | 6 | 6 | 6 | 6 |
| | Total | 111 | 121 | 131 | 151 | 121 | 131 | 151 | 132.5 |
| Specific Gravity | | 0.971 | 1.003 | 1.032 | 1.082 | 1.001 | 1.027 | 1.071 | 1.034 |

The compositions were mixed in a 6 inch×12 inch mill of 1000 g capacity that was supplied with cooling water at 30° C. The mixing conditions were as given below

### Mixing Instructions

| | |
|---|---|
| 0 min | Band rubber “1A”; make 3/4 cuts |
| 2 min | Slowly add “1B”; make 3/4 cuts |
| 9 min | Slowly add “1C”; make 3/4 cuts |
| 10 min | Remove |
| Refine (6 passes) | |

Results are given in Table 6

TABLE 6

| | OOKZ . . . | | | | | | | |
|---|---|---|---|---|---|---|---|---|
| | a | b | c | d | e | f | g | h |
| | ZDA level | | | | | | | |
| | 0 | 10 | 20 | 40 | 0 | 0 | 0 | 20 + A/O |
| | ZDMA Level | | | | | | | |
| | 0 | 0 | 0 | 0 | 10 | 20 | 40 | 0 |
| MDR CURE CHARACTERISTICS | | | | | | | | |
| Frequency: 1.7 Hz; 170° C.; | | | | | | | | |
| 0.5° arc; 60′ | | | | | | | | |
| MH (dN.m) | 12.97 | 22.13 | 34.74 | 70.94 | 19.87 | 29.5 | 51.96 | 30.65 |
| ML (dN.m) | 0.74 | 1.03 | 1.07 | 1.09 | 0.96 | 0.99 | 1.13 | 0.98 |
| Delta MH-ML (dN.m) | 12.24 | 21.1 | 33.68 | 69.85 | 18.91 | 28.51 | 50.84 | 29.66 |
| STRESS STRAIN (DUMBELLS) | | | | | | | | |
| Cure Time at 170° C., (min) | 16 | 15 | 14 | 12 | 16 | 16 | 15 | 14 |
| Stress @ 5 (MPa) | 0.14 | 0.31 | 0.59 | 1.50 | 0.31 | 0.66 | 1.54 | 0.59 |
| Stress @ 10 (MPa) | 0.24 | 0.52 | 1.02 | 2.51 | 0.56 | 1.09 | 2.33 | 1.02 |
| Stress @ 15 (MPa) | 0.33 | 0.70 | 1.37 | 3.25 | 0.77 | 1.46 | 2.91 | 1.34 |
| Stress @ 20 (MPa) | 0.40 | 0.87 | 1.67 | 3.89 | 0.96 | 1.73 | 3.35 | 1.64 |
| Stress @ 25 (MPa) | 0.47 | 1.02 | 1.93 | 4.41 | 1.12 | 1.96 | 3.72 | 1.90 |
| Stress @ 50 (MPa) | 0.71 | 1.65 | 3.10 | 6.91 | 1.72 | 2.88 | 5.38 | 2.92 |
| Stress @ 100 (MPa) | 0.97 | 3.01 | 5.81 | 12.39 | 2.76 | 4.74 | 8.71 | 5.18 |
| Stress @ 200 (MPa) | 1.48 | 8.61 | | 25.59 | 6.21 | 9.66 | 15.04 | 12.62 |
| Stress @ 300 (MPa) | 3.13 | | | | | 16.61 | 22.43 | |
| Ultimate Tensile (MPa) | 4.49 | 9.92 | 14.34 | 25.59 | 10.07 | 18.02 | 28.15 | 17.82 |
| Ultimate Elongation (%) | 342 | 217 | 198 | 200 | 273 | 314 | 358 | 259 |
| Hard. Shore A2 Inst. (pts.) | 72 | 62 | 70 | 75 | 75 | 70 | 85 | 69 |

### EXAMPLE 4

In this example different amounts of ZDA and ZDMA are tested in blends of 60HNBR/40HXNBR. The compositions are given in Table 7.

The mixing conditions were identical to those used in the previous example. Results are given in Table 8.

TABLE 7

| | | a | b | c | d | e | f | g | h |
|---|---|---|---|---|---|---|---|---|---|
| | | ZDA level | | | | | | | |
| | | 0 | 10 | 20 | 40 | 0 | 0 | 0 | 20 |
| | | ZDMA level | | | | | | | |
| | | 0 | 0 | 0 | 0 | 10 | 20 | 40 | 0 |
| HNBR | 1A | 60 | 60 | 60 | 60 | 60 | 60 | 60 | 60 |
| HXNBR | 1A | 40 | 40 | 40 | 40 | 40 | 40 | 40 | 40 |
| NAUGARD 445 | 1B | | | | | | | | 1.1 |
| PARAPLEX G-62 | 1B | 5 | 5 | 5 | 5 | 5 | 5 | 5 | 5 |
| SARTOMER 633 (SR633) | 1B | 0 | 10 | 20 | 40 | 0 | 0 | 0 | 20 |
| SARTOMER 634 (SR634) | 1B | 0 | 0 | 0 | 0 | 10 | 20 | 40 | 0 |
| VULKANOX ZMB-2/C5 | 1B | | | | | | | | 0.4 |
| (ZMMBI) | | | | | | | | | |
| VULCUP 40KE | 1C | 6 | 6 | 6 | 6 | 6 | 6 | 6 | 6 |
| | Total | 111 | 121 | 131 | 151 | 121 | 131 | 151 | 132.5 |
| Specific Gravity | | 0.971 | 1.003 | 1.032 | 1.082 | 1.001 | 1.027 | 1.071 | 1.034 |

TABLE 8

| | a | b | c | d | e | f | g | h |
|---|---|---|---|---|---|---|---|---|
| | 0 | 10 | 20 | 40 | 0 | 0 | 0 | 20 |
| | 0 | 0 | 0 | 0 | 10 | 20 | 40 | 0 |
| MDR CURE CHARACTERISTICS | | | | | | | | |
| Frequency: 1.7 Hz; 170° C.; | | | | | | | | |
| 0.5° arc; 60′ | | | | | | | | |
| MH (dN.m) | 12.38 | 20.99 | 36.10 | 103.62 | 18.16 | 34.65 | 93.72 | 33.04 |
| ML (dN.m) | 0.77 | 1.19 | 1.27 | 1.32 | 1.14 | 1.27 | 1.61 | 1.16 |
| Delta MH-ML (dN.m) | 11.60 | 19.80 | 34.83 | 102.30 | 17.02 | 33.38 | 92.11 | 31.88 |
| ts 1 (min) | 0.98 | 0.49 | 0.52 | 0.63 | 0.60 | 0.68 | 0.93 | 0.59 |
| ts 2 (min) | 1.44 | 0.58 | 0.56 | 0.67 | 0.76 | 0.75 | 1.02 | 0.62 |
| t′ 10 (min) | 1.05 | 0.58 | 0.61 | 0.75 | 0.71 | 0.83 | 1.20 | 0.70 |
| t′ 50 (min) | 3.68 | 2.25 | 1.54 | 1.15 | 3.08 | 2.65 | 2.56 | 1.68 |
| t′ 90 (min) | 13.96 | 8.96 | 6.91 | 4.89 | 9.87 | 8.98 | 7.75 | 7.18 |
| Delta t′50-t′10 (min) | 2.63 | 1.67 | 0.93 | 0.40 | 2.37 | 1.82 | 1.36 | 0.98 |
| STRESS STRAIN (DUMBELLS) | | | | | | | | |
| Cure Time at 170° C., | 19 | 14 | 12 | 10 | 15 | 14 | 13 | 12 |
| (min) | | | | | | | | |
| Stress @ 5 (MPa) | 0.15 | 0.29 | 0.69 | 3.27 | 0.34 | 0.80 | 3.08 | 0.75 |
| Stress @ 10 (MPa) | 0.26 | 0.51 | 1.20 | 5.08 | 0.60 | 1.43 | 4.54 | 1.31 |
| Stress @ 15 (MPa) | 0.34 | 0.70 | 1.68 | 6.33 | 0.81 | 1.87 | 5.47 | 1.80 |
| Stress @ 20 (MPa) | 0.42 | 0.87 | 2.07 | 7.32 | 1.02 | 2.27 | 6.09 | 2.21 |
| Stress @ 25 (MPa) | 0.49 | 1.03 | 2.43 | 8.22 | 1.02 | 2.58 | 6.64 | 2.60 |
| Stress @ 50 (MPa) | 0.72 | 1.70 | 3.97 | 11.62 | 1.89 | 3.74 | 8.47 | 4.16 |
| Stress @ 100 (MPa) | 0.97 | 3.15 | 7.15 | 17.69 | 3.10 | 5.65 | 11.92 | 7.16 |
| Stress @ 200 (MPa) | 1.48 | 7.72 | 16.51 | | 6.38 | 10.41 | 17.99 | 15.34 |
| Stress @ 300 (MPa) | 3.08 | | | | | 17.01 | 25.30 | |
| Ultimate Tensile (MPa) | 4.16 | 11.31 | 21.86 | 28.84 | 10.99 | 20.04 | 28.83 | 15.80 |
| Ultimate Elongation (%) | 339 | 201 | 243 | 192 | 286 | 337 | 343 | 209 |
| Hard. Shore A2 Inst. | 48 | 60 | 76 | 90 | 62 | 78 | 89 | 74 |
| (pts.) | | | | | | | | |

FIG. 1 is a graph of tan δ versus temperature for HXNBR, for HNBR blended with 80 parts of ZDA, for 75HNBR/25HXNBR/60ZDA and 60HNBR/40HXNBR/40ZDA. It is desirable that the peak value of tan δ, which correlates with the glass transition temperature, Tg, shall be as low as possible and shall appear at as low temperature as possible. It will be seen that the two latter compositions that are in accordance with the invention are both superior to the two comparative compositions. FIG. 2 shows the elastic modulus versus temperature for the same compositions and again the superiority of the compositions in accordance with the invention is demonstrated. FIG. 3 is a graph of loss modulus E″ versus temperature and, again, the superiority of the compositions of the invention is demonstrated.

FIG. 4 shows stress-strain curves at 23° C. for five compositions, two of which are in accordance with the invention. It can be seen that these two compositions, composed of 60HNBR/40HXNBR/48ZDA and 75HNBR/25HXNBR/60ZDA, display markedly higher modulus than the other three compositions.

FIG. 5 shows delta torque versus acrylate level in blends of 60HNBR/40HXNBR and 75HNBR/25HXNBR and shows that increased amount of zinc diacrylate and zinc dimethacrylate lead to increases in delta torque, with ZDA being somewhat more effective than ZDMA. The presence of antioxidant (A/O) does not markedly affect results.

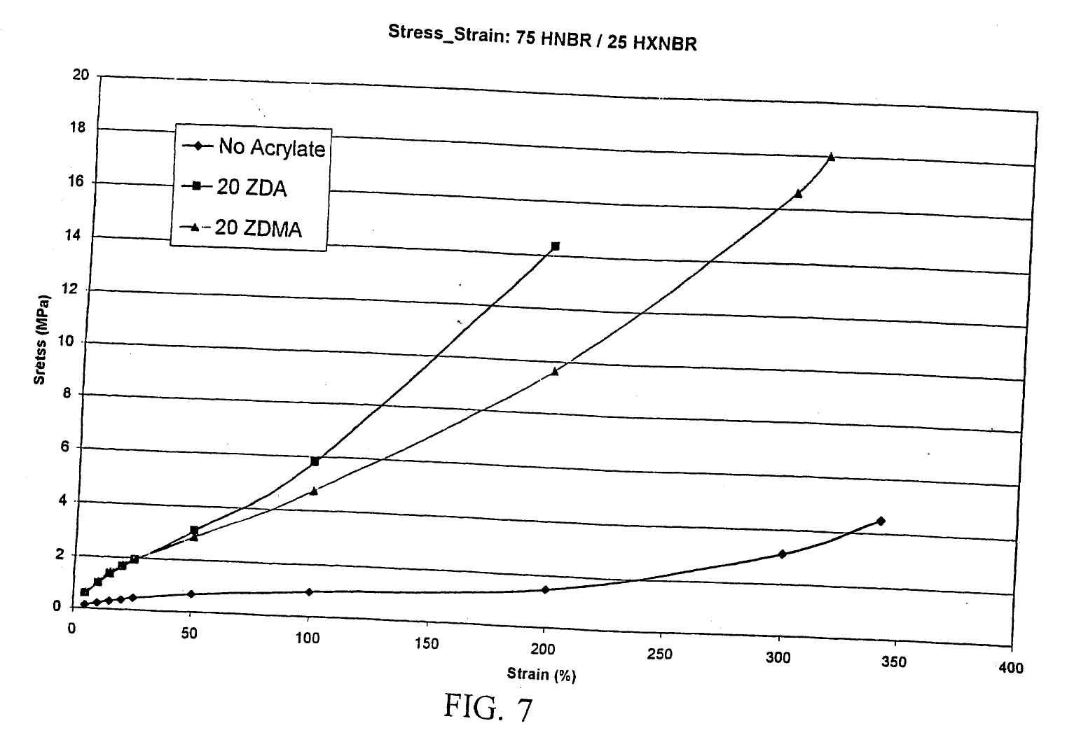

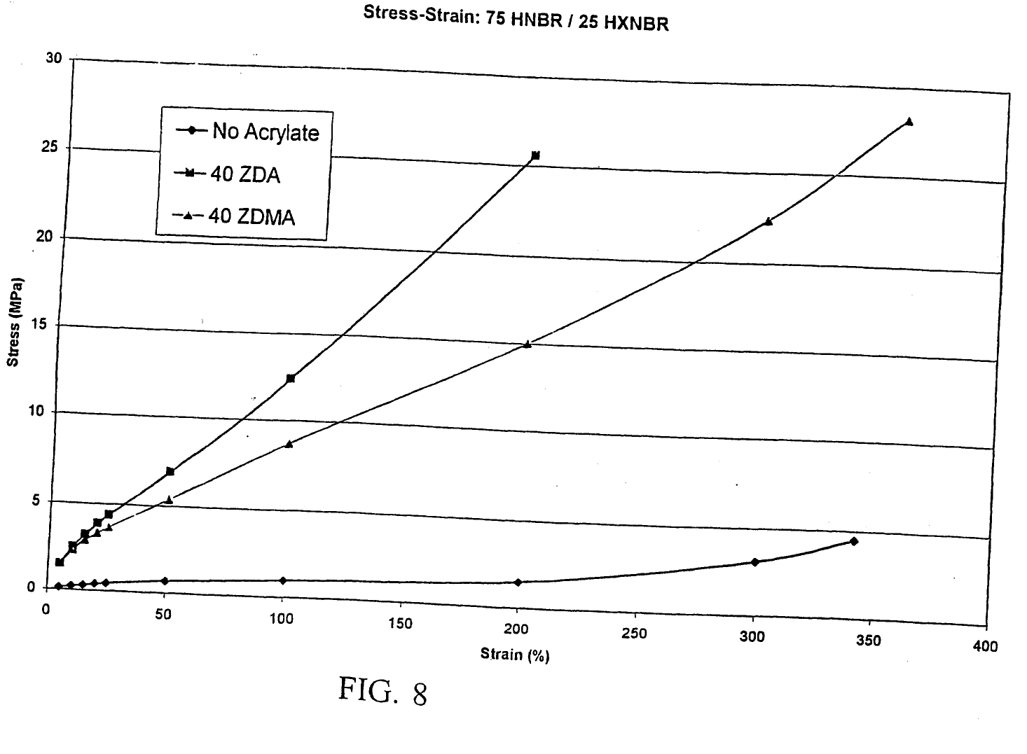

FIG. 6 compares the stress-strain curves of 75HNBR/25HXNBR containing no acrylate, containing 10% ZDA and 10% ZDMA. ZDA is more effective in increasing modulus but ZDMA gives greater elongation at break. FIGS. 7 and 8 shows similar curves but with 20% and 40%, respectively, of ZDA and ZDMA, and show similar results.

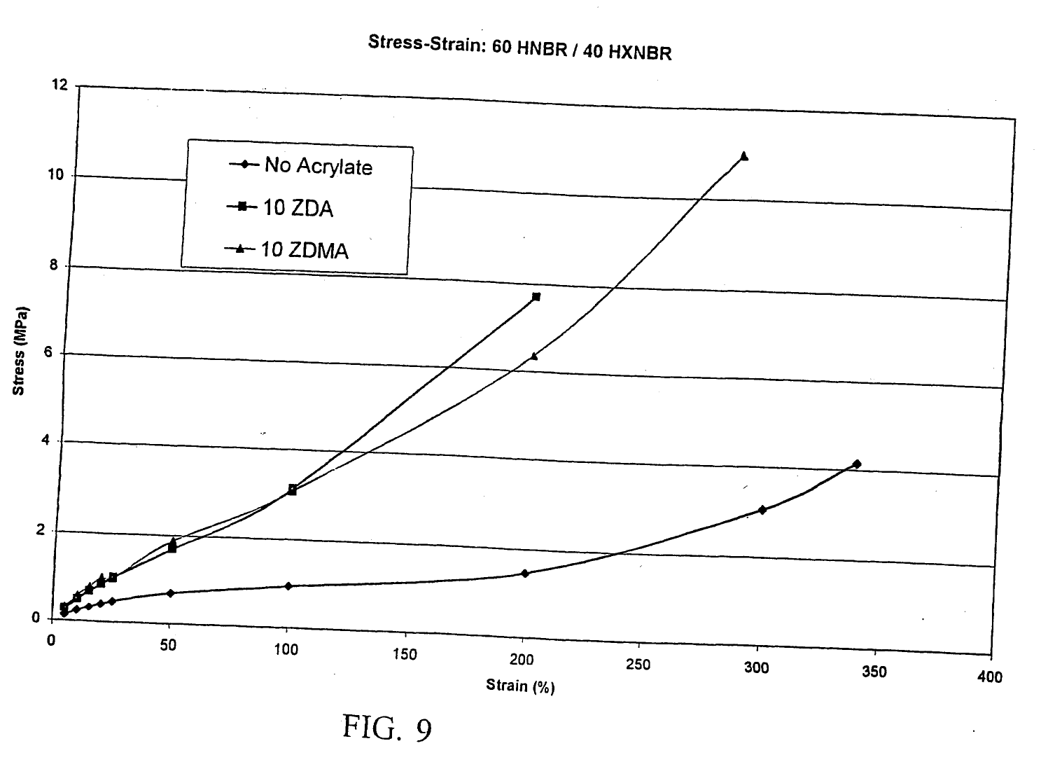

FIGS. 9, 10 and 11 are similar to FIGS. 6, 7 and 8, except that the blend is 60HNBR/40HXNBR. Results are similar to those shown in FIGS. 6, 7 and 8.

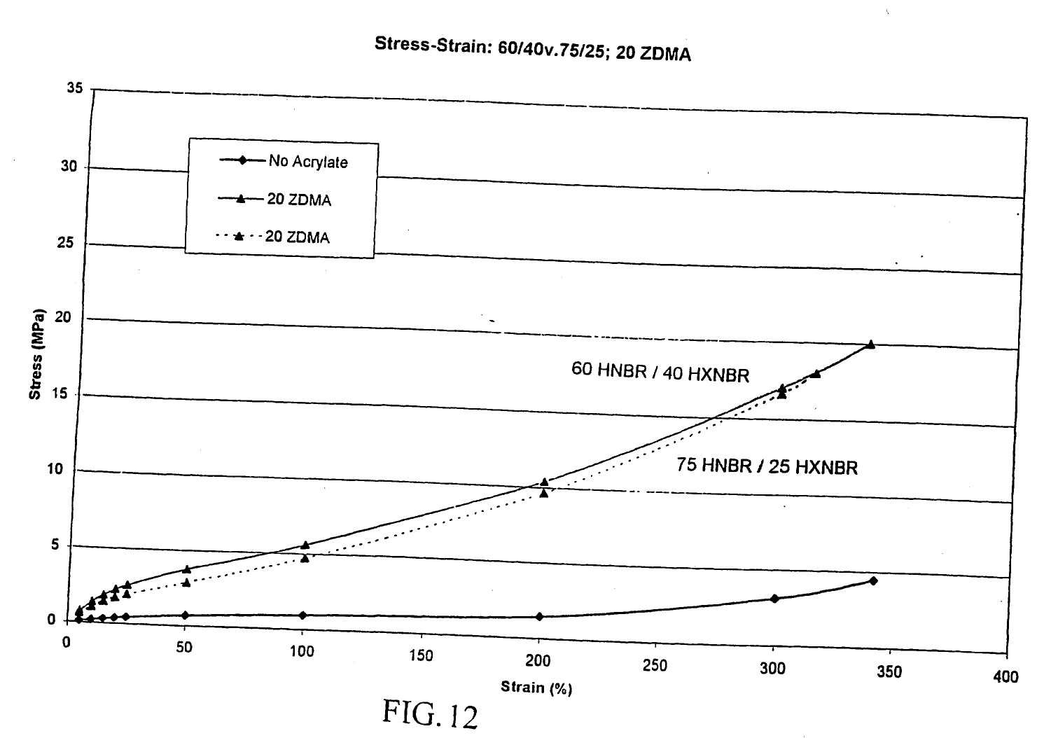

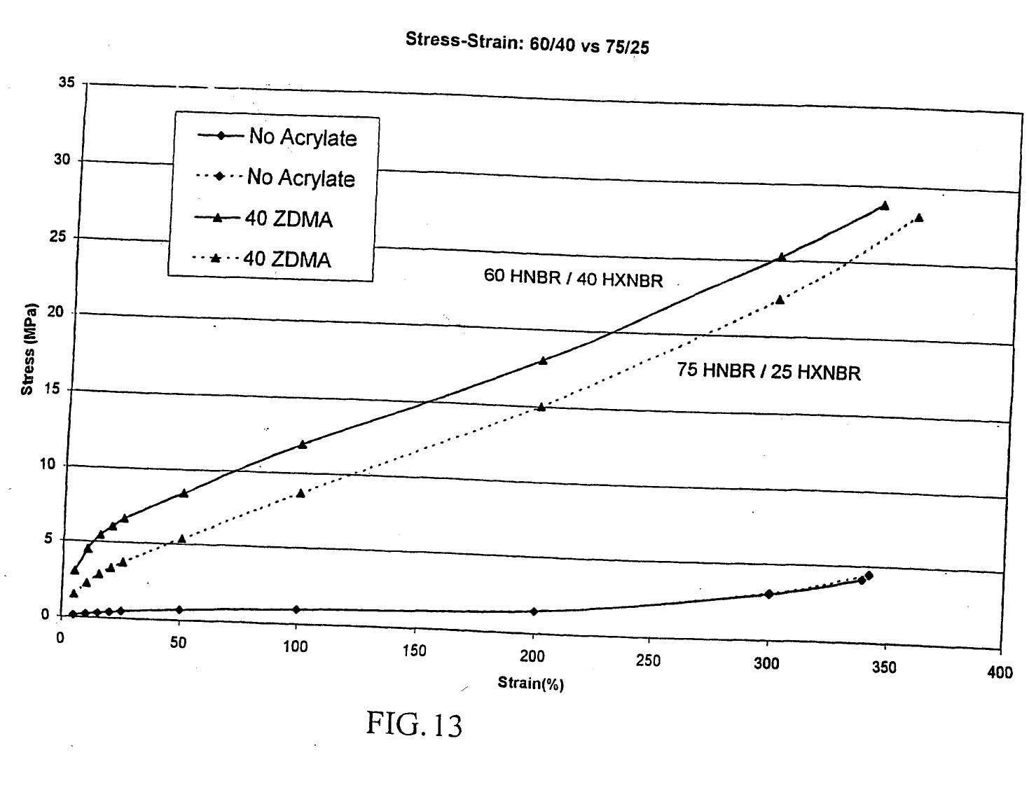

FIG. 12 compares the stress-strain curves of 60HNBR/40HXNBR and 75HNBR/25HXNBR compositions containing 20 parts of ZDMA. The curves are similar, with the 60/40 composition showing slight superiority. FIG. 13 shows somewhat similar results with 40 parts ZDMA, the superiority of the 60/40 composition being more apparent.

FIG. 14 shows delta torque versus ZDA content in 100% HNBR and 100% HXNBR, and demonstrates that at higher levels of ZDA the effect is markedly greater in HXNBR than HNBR.

FIG. 15 shows stress strain curves for 100% HNBR and 100% HXNBR containing no ZDA and containing 40 parts of ZDA. It is noteworthy that, in the absence of ZDA, the rubbers have very similar properties, yet with 40 parts of ZDA the modulus of HXNBR is increased markedly not only over the ZDA-free compositions but also over the HNBR composition containing 40 parts of ZDA.

1. A crosslinkable composition comprising a hydrogenated carboxylated nitrile rubber or a carboxylated nitrile rubber, a peroxide curing agent, and a multivalent salt of an organic acid.

2. A composition according to claim 1, wherein the multivalent ion is divalent and the organic acid is an aliphatic acid having up to 6 carbon atoms.

3. A composition according to claim 1, wherein the salt is zinc diacrylate.

4. A composition according to claim 1, wherein the salt is zinc dimethacrylate.

5. A composition according to any one of claims 1 to 4, which comprises hydrogenated carboxylated nitrile rubber and also contains hydrogenated nitrile rubber.

6. A composition according to claim 5, wherein the amount of hydrogenated nitrile rubber amounts to at least 25% by weight, based on the weight of hydrogenated carboxylated nitrile rubber plus hydrogenated nitrile rubber.

7. A composition according to claim 5 or 6, wherein the amount of hydrogenated nitrile rubber amount is not more than 75% by weight, based on the weight of hydrogenated carboxylated nitrile rubber plus hydrogenated nitrile rubber.

8. A composition according to any one of claims 1 to 7, wherein the amount of the multivalent salt of the organic acid is at least 2 parts by weight per 100 parts by weight of rubber.

9. A composition according to any one of claims 1 to 8, which contains ethylene/propylene/ethylidene norbornene copolymer.

10. A composition formed by crosslinking a composition according to any one of claims 1 to 9.

11. A process for preparing a crosslinkable composition which comprises admixing a hydrogenated carboxylated nitrile rubber or a carboxylated nitrile rubber, a peroxide curing agent and a salt of a multivalent ion and a carboxylic acid.

12. A process according to claim 11, wherein a hydrogenated carboxylated nitrile rubber is admixed with the peroxide curing agent and the salt of a multivalent ion and carboxylic acid.

13. A process according to claim 12, wherein there is also admixed a hydrogenated nitrile rubber.

14. A process according to claim 13, wherein the amount of hydrogenated nitrile rubber is from about 25 to about 75% by weight, based on the weight of hydrogenated nitrile rubber plus hydrogenated carboxylated nitrile rubber.

15. A process according to any one of claims 11 to 14, wherein the salt is zinc acrylate.

16. A process according to any one of claims 11 to 14, wherein the salt is zinc dimethacrylate.
